(19) United States
(12) Patent Application Publication
(10) Pub. No.: US 2026/0183164 A1
(43) Pub. Date: Jul. 2, 2026

(54) PATIENT SUPPORT APPARATUS WITH A MATTRESS CABLE GUIDE

(71) Applicant: Stryker Corporation, Portage, MI (US)

(72) Inventors: Matthew T. Thielking, Schoolcraft, MI (US); Eric Hudson, Portage, MI (US); David Scharich, III, Coloma, MI (US)

(21) Appl. No.: 19/421,481

(22) Filed: Dec. 16, 2025

Related U.S. Application Data
(60) Provisional application No. 63/739,756, filed on Dec. 30, 2024.

(51) Int. Cl. A61G 7/018; A61G 7/05; H01R 13/633

(52) U.S. Cl. CPC A61G 7/018; A61G 7/0507; H01R 13/633

(57) ABSTRACT

A cable support for a mattress cable for a patient support apparatus that provides data and/or power to a mattress. The cable support may be operable to redirect a pulling force applied to a cable to a disengagement force that breaks a connection for a connector assembly without binding the connectors of the connector assembly.

### TECHNICAL FIELD

The present disclosure relates to patient support apparatuses, such as beds, cots, stretchers, recliners, or the like, and more particularly to a guide for a cable for a pad or mattress.

### BACKGROUND

Existing patient support apparatuses, such as hospital beds and/or stretchers, often include a pad or mattress to form a patient support surface. The pads or mattresses are typically supported on an articulatable litter deck (often referred to as the “Litter”), with a back deck section (referred to as the “Fowler”), a seat deck section, and a thigh deck section, which may or may not have a separate foot deck section, with some of the deck sections being adjustable to allow a caregiver or patient to adjust the angle of the respective deck section. To adjust the deck configuration, the patient support apparatus includes actuators to move the respective deck sections.

More recently, patient support surfaces have become smarter surfaces—they may have sensors, or they may have controls to inflate or deflate bladders that may be incorporated into the patient support surface. In some cases, the litter deck and/or the patient support surface is configured to widen and/or lengthen to accommodate larger or taller patients.

The sensors may be used for feedback on the control of the bladders or may be used to monitor the patient, such as vital signs, temperature, and moisture (e.g., at the interface with the patient support surface). Further, some mattresses with bladders, which form at least part of the patient support surface, may incorporate a pump or pumps and pneumatic control systems, as well as logic systems, typically in a housing at the foot end of the mattress. As a result, patient support surfaces may have one or more cables to provide power, data, etc., to or from the patient support surface to controls located in the patient support apparatus or other controls, such as external pump control housings, which may be supported on the footboard. These cables, however, can limit or be damaged by movement of the mattress, for example, when a caregiver needs to lift up the mattress, for example to clean under the mattress, or when the mattress or patient support apparatus is lengthened. Additionally, these cables may interfere with or be damaged by side rails when the side rails are raised or lowered, given their proximity to the side rails.

### SUMMARY OF THE DESCRIPTION

In general, one innovative aspect of the subject matter described herein can be embodied in a patient support apparatus comprising a frame and a side rail mounted relative to the frame. The side rail may be spaced from the frame and movable between raised and lowered positions. The patient support apparatus may include a mattress supported relative to the frame and a mattress cable assembly for power and/or communications. The mattress cable may include a first cable portion connected to the mattress and a first connector coupled to the first cable portion connected and connectable to a second connector. The first connector and the second connector may form a connector assembly configured as a breakaway connection. The first connector and the second connector may define a connection axis therebetween along which the first connector and the second connector are configured to be engaged and disengaged. The patient support apparatus may include a cable support operable to redirect a pulling force applied on the first cable portion to break the first connector away from the second connector without applying force on the first connector that is substantially transverse to the connection axis.

The foregoing and other aspects can each optionally include one or more of the following features, alone or in combination. In particular, one aspect includes all the following features in combination.

In some aspects, the first cable portion may have a longitudinal axis that extends between the first and second connectors, where the first cable portion may be flexible such that the longitudinal axis is capable of being substantially aligned with the connection axis.

In some aspects, the cable support may include a guide surface that is curved to redirect the pulling force to break the first connector away from the second connector, where a curvature of the guide surface may be configured to avoid applying force on the first connector that is substantially transverse to the connection axis.

In some aspects, the curvature of the guide surface may include an apex that is spaced away from the second connector by a distance D.

In some aspects, the distance D may be defined along the connection axis.

In some aspects, the distance D may be sufficiently large so as to enable the first connector to completely disengage from the second connector.

In some aspects, the curvature of the guide surface may have a radius that is greater than or equal to a bend radius of the first cable portion.

In some aspects, the curvature of the guide surface may define one of a half-circle or a spline curve.

In some aspects, the second connector may be a panel mount connector.

In some aspects, the cable support may include an opening through which the first connector is capable of passing. The opening may include an inner perimeter surface configured to limit transverse movement of the first cable portion relative to the connection axis.

In general, one innovative aspect of the subject matter described herein can be embodied in a cable support for a patient support apparatus. The patient support apparatus may include a frame on which a mattress is supported, and a mattress cable assembly with a first connector coupled to a first cable portion and connectable to a second connector. The first connector and the second connector may form a connector assembly configured as a breakaway connection. The first connector and the second connector may define a connection axis therebetween along which the first connector and the second connector are configured to be engaged and disengaged. The cable support may include a first guide surface that defines an opening through which the first cable portion and the first connector are capable of passing through, the first guide surface being operable to align a pulling force on the first cable portion in a direction that is substantially transverse to the connection axis. The cable support may include a second guide surface that is curved to redirect the pulling force applied on the first cable portion to break the first connector away from the second connector without applying force on the first connector that is substantially transverse to the connection axis.

The foregoing and other aspects can each optionally include one or more of the following features, alone or in combination. In particular, one aspect includes all the following features in combination.

In some aspects, the first cable portion may have a longitudinal axis that extends between the first and second connectors, where the first cable portion may be flexible such that the longitudinal axis is capable of being substantially aligned with the connection axis.

In some aspects, a second guide surface may be curved to redirect the pulling force to break the first connector away from the second connector, where a curvature of the second guide surface may be configured to avoid applying force on the first connector that is substantially transverse to the connection axis.

In some aspects, the curvature of the guide surface may include an apex that is spaced away from the second connector by a distance D.

In some aspects, the distance D may be defined along the connection axis.

In some aspects, the distance D may be sufficiently large so as to enable the first connector to completely disengage from the second connector.

In some aspects, the curvature of the guide surface may have a radius that is greater than or equal to a bend radius of the first cable portion.

In some aspects, the curvature of the guide surface may define one of a half-circle or a spline curve.

In some aspects, the second connector may be a panel mount connector.

In some aspects, the connector assembly may be configured as a magnetic breakaway connector assembly.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### BRIEF DESCRIPTION OF THE DRAWINGS

FIG. 1 shows a patient support apparatus in one aspect.

FIG. 2 shows a patient support and a cable assembly according to one aspect.

FIG. 3A shows a mattress control housing in one aspect.

FIG. 3B shows a mattress control housing in one aspect.

FIG. 4 shows a litter frame and a connector according to one aspect.

FIG. 5 shows the litter frame along with a cable portion according to one aspect.

FIG. 6 shows a bottom perspective view of a cable support according to one aspect.

FIG. 7 shows a top perspective view of the cable support according to one aspect.

FIG. 8 shows a cross section of the cable support in FIGS. 6 and 7.

FIG. 9 shows a perspective cross section view of the cable support in FIG. 8.

### DESCRIPTION

In one aspect, a cable support is provided for a mattress cable for a patient support apparatus that provides data and/or power to a mattress. The cable support may be operable to redirect a pulling force applied to a cable to a disengagement force that breaks a connection for a connector assembly without binding the connectors of the connector assembly.

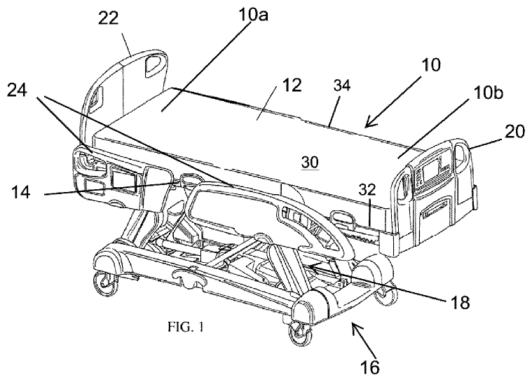

Referring to FIG. 1, the numeral 10 generally designates a patient support apparatus. Although the particular form of a patient support apparatus 10 illustrated in FIG. 1 is a bed adapted for use in a hospital or other medical setting, it will be understood that a patient support apparatus 10 may be a cot, a stretcher, a gurney, a recliner, a residential bed, or any other structure capable of supporting a patient, whether stationary or mobile and/or whether used in a medical or residential setting.

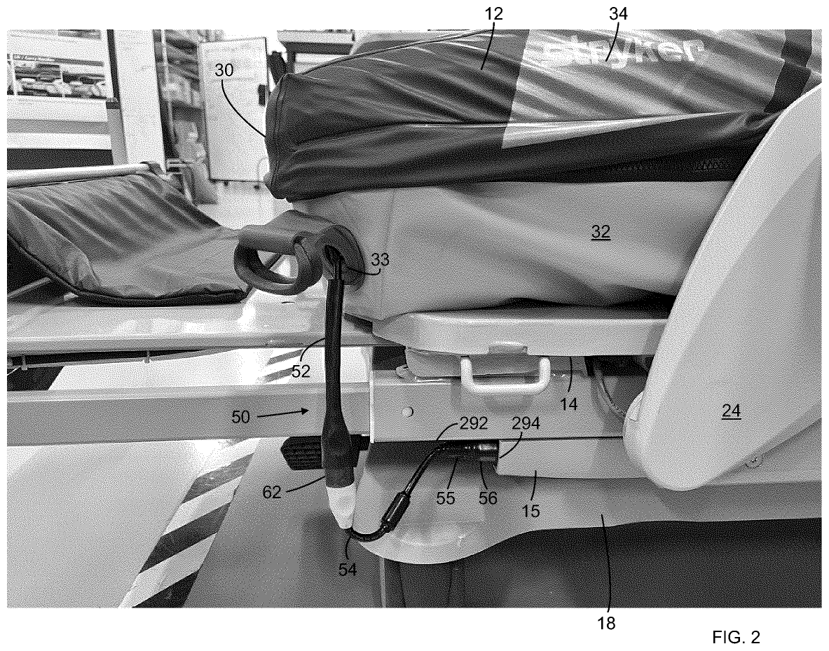

In general, a patient support apparatus 10 includes a mattress 12 that is supported on a litter deck 14 (e.g., a patient support deck), which in turn is supported on a litter frame 15 (e.g., FIG. 2). The litter deck 14 may have one or more articulatable deck sections, including a back deck section (“Fowler”), a seat deck section, and a thigh deck section, which together with the litter frame 15 are supported on a wheeled base 16 by a lift assembly 18. The patient support apparatus 10 further includes a footboard 20, a headboard 22, and a plurality of side rails 24. Side rails 24 are all shown in a lowered position in which ingress into, and egress out of, a patient support apparatus 10 is not obstructed by the lowered side rails 24. Each side rail is configured so it can be individually moved to a raised position. Side rails 24 may be moved to one or more intermediate positions as well.

The lift assembly 18 is adapted to raise and lower the litter frame and litter deck 14 with respect to the base 16 and may incorporate actuators, such as electric actuators, hydraulic actuators, pneumatic actuators, or any other suitable device for extending the lift assembly 18 for raising and lowering the litter frame and litter deck 14. The actuators may be operated independently so that the litter frame and litter deck may be tilted (with respect to the base 16), such as in a Trendelenburg orientation or in a reverse Trendelenburg orientation. The patient support apparatus 10 may also incorporate actuators, such as electric actuators, hydraulic actuators, pneumatic actuators, or any other suitable device, for moving the individual deck sections. The head deck section, which as noted may be referred to as the Fowler, is pivotable about a generally horizontal pivot axis between a generally horizontal orientation (shown in FIG. 1) and a plurality of raised positions (not shown). The thigh deck section (and optional foot deck section) may also be pivotable about generally horizontal pivot axes.

In some aspects, a patient support apparatus 10 may be modified from what is shown to include one or more components adapted to allow the user to extend the width of the litter deck 14, thereby allowing the patient support apparatus 10 to accommodate patients of varying sizes. For example, the width of litter deck 14 may be adjusted, between a first width, a second or intermediate width, and a third or expanded width. The first width may be, for example, a 36-inch width, the second intermediate width may be, for example, a 42-inch width, and the third expanded width may be, for example, a 48-inch width, although these widths may be varied.

As used herein, the term “longitudinal” refers to a direction parallel to a central axis between the head end 10a and the foot end 10b of the patient support apparatus 10. The terms “transverse” or “lateral” refer to a direction perpendicular to the longitudinal direction and parallel to a surface on which the patient support apparatus 10 rests.

The mattress 12 may comprise a variety of different mattresses with a variety of different cushioning components, such as foam, foam in combination with bladders, foam in combination with one or more gel layers, or foam in combination with bladders and one or more gel layers, and may include a mattress control system incorporated into the mattress and contained, for example, within the foot end of the mattress in a mattress control housing, such as disclosed in U.S. Pat. Nos. 5,542,136, 5,325,551, 8,910,334, 8,911,387, 7,406,736, 9,820,904, and 9,468,307, which are commonly owned by Stryker Corporation of Kalamazoo, Michigan, and are incorporated by reference in their entireties herein.

In one aspect, the mattress 12 may include a cover 30 that includes an upper cover portion 34 and a lower cover portion 32, which may be joined together at a seam by a perimeter zipper, such as a full perimeter zipper or partial perimeter zipper, to facilitate removal for cleaning or replacement of the cover from the mattress 12. The upper and lower portions 34, 32 of the cover 30 may be joined by a seam formed by stitching so that the upper cover portion 34 is not completely detachable from the lower cover portion 32, and with the remainder of the upper and lower portions 34, 32 of the cover 30 joined with a partial perimeter zipper, e.g., a zipper that extends only around a portion of the perimeter of the main cushion 12. The location of the zipper may vary, but in one aspect the zipper is located along longitudinal and lateral sides between the top and lower sides of the mattress 12 and, optionally, about midway between the top and lower sides of the mattress 12.

The cover 30 may, for example, be formed from a flexible liquid impermeable panel of material, such as polyurethane, polyurethane coated fabrics, or nylon, which forms the exterior surface of the cover 30. Further, the cover 30 may include one or more additional panels of material similar to or the same as the exterior surface panel. Additional panels may be joined with the exterior surface panel, for example, by stitching, and may form the inner or interior surface of the cover 30.

In order to supply power to and/or communicate with the components within the mattress control housing, the patient support apparatus 10 includes a cable 50, which is in communication with the mattress control board in the mattress control housing. The cable 50 may be in communication with cabling that extends through the litter frame 15, with the main patient support control board or another control board, such as a control board in the footboard or with an external pump control housing mounted to the footboard.

As best seen in FIG. 2, the cable 50 couples to the mattress at the foot end of the mattress (where the mattress control housing is located, as noted) to provide power and/or data to the mattress. The cable 50, optionally described herein, may be provided in separate portions with a connector therebetween and a connection to the patient support. The optional connector may use an additional length cabling over configurations without the optional connector, and this additional length of cabling may be challenging to manage in cases where the bed is configured to lower close to the floor and/or with low caster height bed configurations. Use of a panel mount connector as described herein without the optional connector may address these concerns—however, if the panel mount connection is in a horizontal orientation, pulling the cable 50 upward (such as when the mattress 12 is lifted for cleaning) does not allow the cable 50 to disconnect, potentially resulting in cable damage. One aspect according to the present disclosure may enable use of a horizontally aligned panel mount connector (e.g., a bed connector 56) and allow for the direction of force/cable motion to be changed to allow the cable to properly disconnect while maintaining adequate fluid ingress protection. This way, changing the orientation of the bed connector 56 to provide a connection axis 57 that is in a vertical position can be avoided, avoiding fluid ingress and cleaning concerns resulting from a vertically positioned bed connector 56.

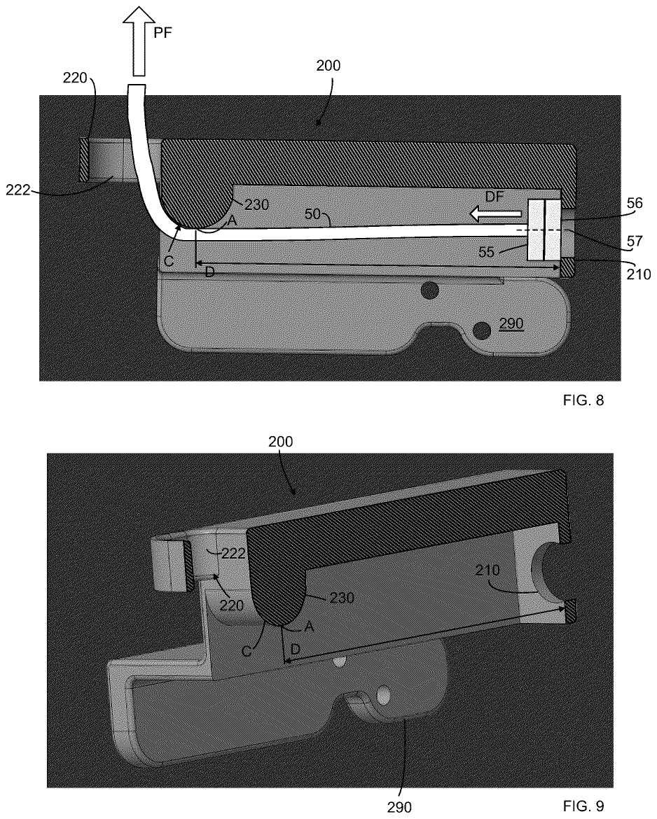

The cable 50 is configured with a first, upper cable portion 52 that is connected to the mattress, namely to the mattress control board in the mattress control housing 70. The cable may include a main connector 55 that connects to cabling supported in the litter frame 15 via the bed connector 56. The bed connector 56 may be mounted to the underside of the litter frame 15. As noted above, the cabling supported by the litter frame may be in communication with the main control board on the patient support apparatus or another control board, either directly or through the main control board. The main connector 55 and the bed connector 56 may form a breakaway connection (e.g., a magnetic breakaway connection). The main connector 55 and the bed connector 56 may be mated together along a connection axis 57 (see FIG. 8), along which the main connector 55 may engage with and disengage from the bed connector 56.

The main connector 55 and the bed connector 56 provide a breakaway connection. The main connector 55 and the bed connector 56, when connected, allow the cable 50 to communicate (via electrical current and/or signals) through the main connector 55 and the bed connector 56 and when disconnecting the cable 50 from the patient support apparatus. For example, the main connector 55 and the bed connector 56 may form a connector assembly that may be a magnetic breakaway connector assembly, such as is available from Onanon. Further, one of the connectors of this connector assembly may comprise a female magnetic connector, and the other a male magnetic connector. Alternately or additionally, one or both connectors may be keyed to ensure alignment and connection between the two connectors.

Optionally, the cable 50 may include two cable portions with the upper cable portion 52 and a second, lower cable portion 54 that is connected to cabling supported in the litter frame via the bed connector 56. The cable 50 may optionally include a connector assembly 62 in line between the mattress 12 and the bed connector 56. The connector assembly 62 may include a first connector 58 coupled to the distal end of the upper cable portion 52 and a second connector 60 coupled to the upper end of the lower cable portion 54. The connector assembly 62 may provide a breakaway connection, similar to the breakaway connection described in U.S. Publication 2024/0404728 to Thielking et al., published Dec. 5, 2024, and incorporated herein by reference in its entirety.

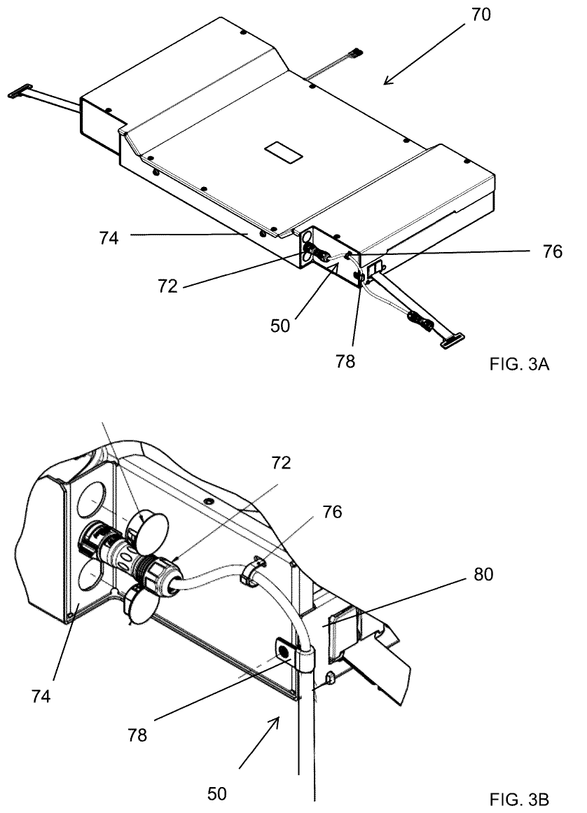

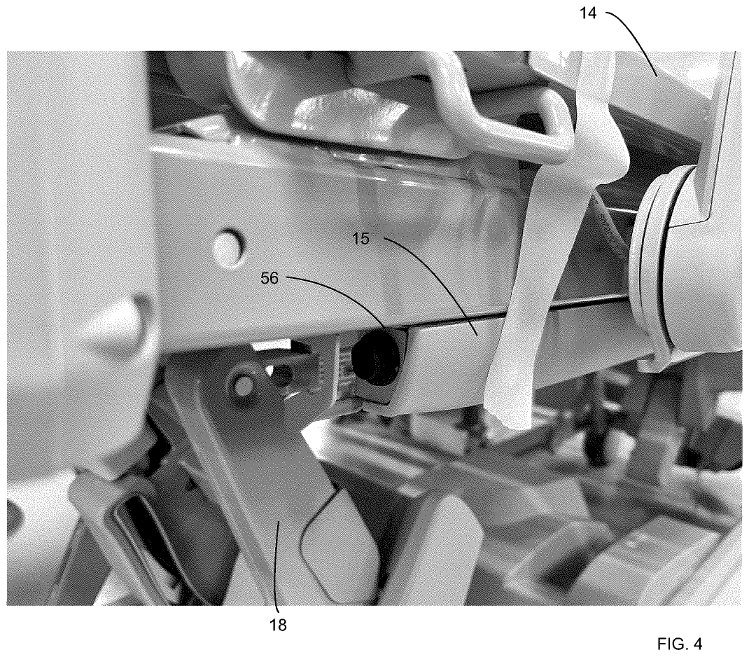

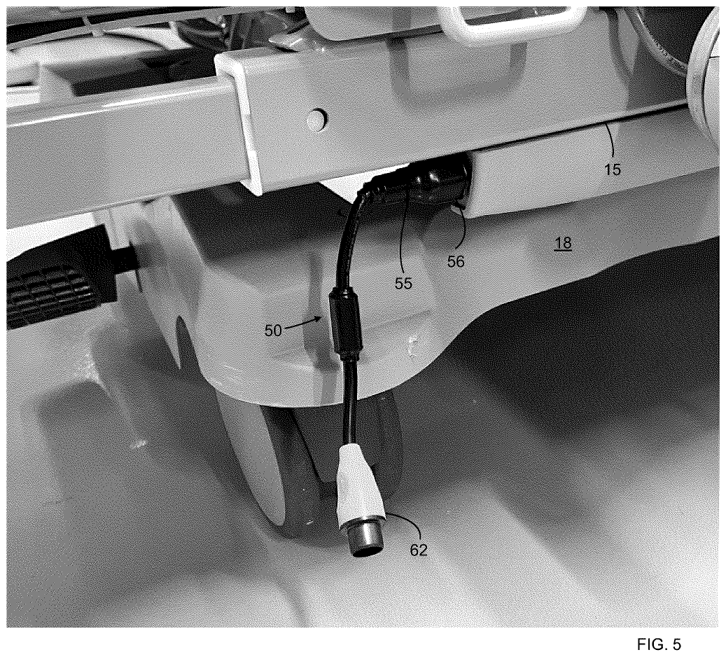

As can be seen in FIGS. 3A and 3B, the cable 50, which extends from the mattress 12 (see FIG. 2), extends from the mattress control housing 70, which houses the mattress control board and any pneumatics for controlling bladders in the mattress. The mattress control housing 70 is located in the foot end of the mattress 12 and may have a connection 72 mounted in the side wall 74 of the mattress control housing 70 for the cable 50 to couple to the mattress control board or an opening to allow the cable 50 to pass through the housing and connect directly with the mattress control board.

In the illustrated aspect, the cable 50 is mounted to and connected with the mattress control housing 70 at two locations. Again, referring to FIGS. 3A and 3B, a first connection 76 is provided that may provide a guide to the support cable 50 as it exits or extends from the mattress control housing. A suitable guide may comprise a c-clip.

A second connection 78 may be provided to support and anchor the cable 50 to the outer side 80 of the mattress control housing 70 to locate the cable in a vertical orientation relative to the mattress housing and, hence, the mattress 12 and, further, in space or in an envelope relative to the patient support apparatus 10 between the side rail 24 and the litter deck 15. The second connection 78 may be provided by a p-clip and is located along a portion of the cable 50.

The cable 50 may pass through an aperture 33 (see FIG. 2) in the cover 30 such that the first connector 58 is accessible externally to the cover 30 for connection to the second connector 60. The second connection 78 may be proximal to the aperture in the cover 30, providing support for the positioning of the cable 50 without substantially relying on the aperture in the cover 30 to support the cable 50. In FIG. 2, the aperture 33 in the cover 30 is provided in the lower cover portion 32.

It should be understood a patient support apparatus 10, therefore, includes a frame or frames that supports the mattress, which include a litter frame and an articulatable litter deck supported by or on the litter frame. The frame also supports the footboard and the side rails, which are movable relative to the litter frame and mattress from one or more raised positions to a lowered position and is spaced by a distance from the litter frame to form a vertical envelope. The litter deck 14 has a top side, which further defines a horizontal plane within the envelope which is desirable to locate the connector assembly to avoid interference from the nearest side rail (e.g., foot end side rail) as it is raised and lowered. Thus, the cable with its stiffening sleeve extends from or near the foot end of the mattress through the envelope to the frame, and the connector assembly that provides the breakaway connection may be located in the envelope below the top side of the litter deck.

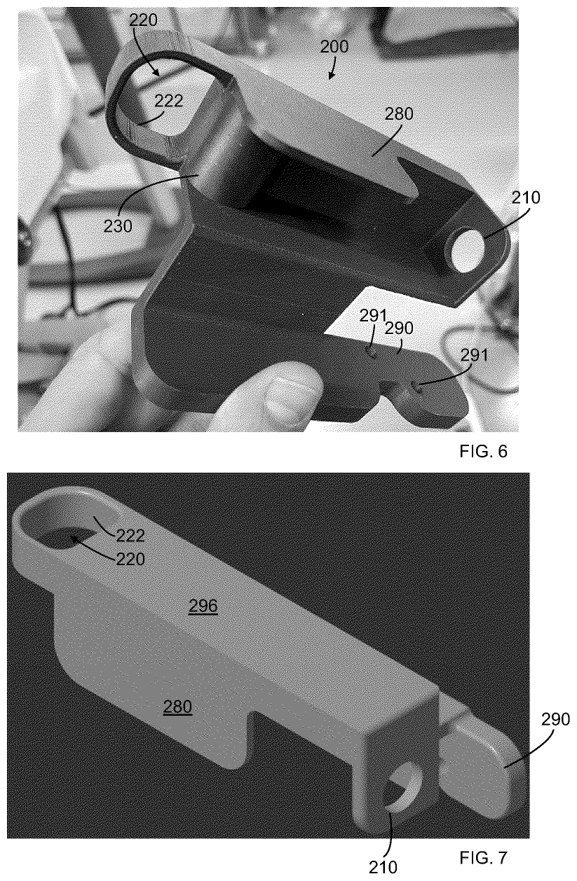

Turning to FIGS. 6-9, a cable guide assembly also described as a cable support in one aspect is shown and generally designated 200. The cable support 200 may be mounted to the litter frame 15 proximal to the bed connector 56, so that an upper surface 296 of the cable support 200 is disposed on a lower surface 292 (shown in FIG. 2) of the litter frame 15, and so that a guide assembly mount 290 proximal to a connector opening 210 is disposed on a surface 294 of the litter frame 15. The cable support 200 may be fixedly mounted to the litter frame 15 via a guide assembly mount 290, which may include one or more mounting holes 291 operable to receive a fastener for attaching the guide assembly mount 290 and therefore the cable support 200 to the litter frame 15. It is to be understood that although the cable support 200 is mountable to the litter frame 15 relative to the bed connector 56 in one aspect, however, the present disclosure is not so limited and the cable support 200 may be positioned at any location on the patient support in a manner operable to facilitate disengagement of the main connector 55 from the bed connector 56.

The cable support 200 may be configured to translate vertical force on the cable 50 into horizontal force/motion. Although the cable support 200 is stationary, it may be configured to act in a pulley-like manner. The main connector 55 may safely disconnect when the foot end of the mattress 12 is lifted for cleaning. The panel mount connector (e.g., the bed connector 56) may be mounted in the horizontal position and shielded from fluid ingress.

The cable support 200 in FIGS. 6-9 includes an opening 220 through which the main connector 55 and the cable 50 are capable of passing through. In other words, the size of the opening 220 may be sufficiently large so as to enable passage of the main connector 55 as well as the cable 50. The opening 220 may be defined by an opening surface 222 (e.g., a guide surface) that surrounds the cable 50 and is configured to maintain a position of the cable 50 relative to a guide surface 230. The opening surface 222 may contact a side of the cable 50 to maintain its position relative to the guide surface 230. The position as described herein may be generally perpendicular relative to a connection axis of the main connector 55 and the bed connector 56—although the position may vary depending on the configuration. In one aspect, the opening 220 and the opening surface 222 of the opening 220 may be configured to support the cable in general alignment with the direction at which the cable 50 exits the cover 30 of the mattress 12. Further, the opening 220 may limit (within a range) transverse movement of the cable 50 relative to the connection axis 57.

The bed connector 56 in one aspect may be disposed in a fixed position relative to a bed connector mount 210, which may vary in construction from application to application. In FIGS. 6-9, the bed connector mount 210 of the cable support 200 may be provided in the form of a wall of the cable support 200 and an opening or notch in the wall to which the bed connector 56 may be fastened. For instance, the bed connector 56 may be a panel mount connector adapted to be attached to the wall of the bed connector mount 210 and the cable support 200 with the bed connector 56 fitting at least partially through the opening of the bed connector mount 210 so that one or more wires associated with the bed connector 56 may pass through the opening of the bed connector mount 210.

As described herein, the opening 220 in conjunction with the guide surface 230 may redirect a pulling force PF into a disengagement force DF applied on the cable to facilitate disengaging the main connector 55 from the bed connector 56. Redirection of the pulling force PF to the disengagement force DF may be provided at least in part by the guide surface 230, which may be spaced away from the bed connector 56 by a distance D.

The distance D may vary from application to application, depending on the construction of the cable 50, the bed connector 56, and the main connector 55. The distance D may be sufficiently large so as to enable the main connector 55 to completely disengage from the bed connector 56 before contacting the guide surface 230. This way, the main connector 55 may avoid contacting the guide surface 230 before disengaging from the bed connector 56, thereby substantially preventing the guide surface 230 from applying substantial transverse force (relative to the connection axis 57) on the main connector 55 as it disengages from the bed connector 56.

The distance D may be defined by the distance between the bed connector mount 210 or an aspect thereof and an apex A of the guide surface 230 along the connection axis 57—although it is to be understood that the distance D may be defined differently in order to provide sufficient space for the main connector 55 to disengage from the bed connector 56 along the connection axis 57 without binding (e.g., without application of a substantial amount of force transverse to the connection axis 57 that causes binding between the connectors).

The guide surface 230 may be defined by the surface having a curvature C and an apex A as discussed herein. The curvature C may be provided to redirect the pulling force PF on the cable into the disengagement force DF. For instance, in FIGS. 8-9, it can be seen that the curvature C is a half-circle that defines the apex A. The curvature C may vary from application to application and is not limited to a half-circle. For instance, a spline curve may be utilized to define a curvature C that is different from a half-circle. The curvature C may be configured to provide a transition between the opening surface 222 and the apex A that facilitates redirecting the pulling force PF into a disengagement force DF, which may be tangential to the apex A of the curvature C. In FIG. 8, it can be seen that the pulling force PF can be redirected almost 90 deg. to the disengagement force DF.

The radius of the curvature C, in one aspect, may be greater than or equal to a bend radius of the cable 50. This way, the cable 50 may be sufficiently flexible so as to engage the curvature C and redirect the pulling force PF.

The connection axis 57 in one aspect may be substantially aligned with the apex A—although as described herein, the apex A may deviate from the connection axis 57 while still avoiding providing a disengagement force DF with substantial force component transverse to the connection axis 57. Increasing the distance D can further reduce the amount of a transverse force component in the disengagement force DF relative to the component force of the disengagement force DF that is parallel to the connection axis 57.

The amount of redirection may vary from application to application and from use to use. For instance, in FIG. 8, the cable 50 may be pivoted by several degrees relative to the curvature C and apex A, so that from use to use the cable 50 may be pulled at variety of angles while the guide surface 230 may still redirect such a pulling force PF to the disengagement force DF without applying a substantial amount of force on the main connector 55 transverse to the connection axis 57. The cable 50 may be sufficiently flexible to engage with the curvature C of the guide surface 230 and redirect the pulling force PF to the disengagement force DF.

The disengagement force DF may be aligned with a longitudinal axis of the cable 50 between the apex A and the main connector 55. It is noted that this disengagement force DF may not be exactly parallel to the connection axis 57, as seen in FIG. 8. For instance, the disengagement force DF may be substantially aligned with the connection axis 57, but the disengagement force DF may have a component force that is transverse to the connection axis 57—however, this component force is not substantial so as to cause binding between the main connector 55 and the bed connector 56.

The cable support 200 may include a side surface 280 that may further facilitate maintaining a position of the cable 50 relative to the guide surface 230 and the opening 220 so that, when a pulling force PF is applied, the cable 50 is in position to engage the curvature C of the guide surface 230 to yield the disengagement force DF that disengages the main connector 55 from the bed connector 56. The side surface 280 may cooperate in conjunction with a surface of the guide assembly mount 290 to maintain the position of the cable 50.

For examples of mattresses with pneumatic systems that employ various bladders to support a patient and bladders to provide therapeutic functions, reference is made to U.S. Pat. Nos. 8,910,334, 8,911,387, 7,406,736, 9,820,904, and 9,468,307, which are commonly owned by Stryker Corporation of Kalamazoo, Michigan, and are incorporated by reference in their entireties herein.

Another suitable mattress is disclosed in commonly assigned U.S. patent application Ser. Nos. 61/696,819, which is the provisional application to U.S. Non-Provisional application Ser. No. 13/836,813, now U.S. Pat. Nos. 9,468,307, and 61/697,010, which is the provisional application to U.S. Non-Provisional application Ser. No. 14/019,353, now U.S. Pat. No. 9,420,895, entitled INFLATABLE MATTRESS AND CONTROL METHODS and PATIENT SUPPORT, respectively, both of which were filed on Sep. 5, 2012, which are hereby incorporated herein by reference in their entireties. Such mattresses comprise a plurality of inflatable bladders whose inflation pressure is controllable by one or more controllers contained with the mattress. The mattress may further comprise a plurality of sensors used for detecting information about the status of the mattress, such as, but not limited to, one or more depth sensors, fluid pressure sensors, temperature sensors, patient interface pressure sensors, and/or humidity sensors.

It will be understood by those skilled in the art that patient support apparatus 10 can be designed with other types of mechanical constructions, such as, but not limited to, that described in commonly assigned, U.S. Pat. No. 10,130,536 to Roussy et al., entitled PATIENT SUPPORT USABLE WITH BARIATRIC PATIENTS, the complete disclosure of which is incorporated herein by reference. In another aspect, the mechanical construction of patient support apparatus 10 may be the same as, or nearly the same as, the mechanical construction of the Model 3002 S3 bed manufactured and sold by Stryker Corporation of Kalamazoo, Michigan. This mechanical construction is described in greater detail in the Stryker Maintenance Manual for the MedSurg Bed, Model 3002 S3, published in 2010 by Stryker Corporation of Kalamazoo, Michigan, the complete disclosure of which is incorporated herein by reference. It will be understood by those skilled in the art that patient support apparatus 10 can be designed with still other types of mechanical constructions, such as, but not limited to, those described in commonly assigned, U.S. Pat. No. 7,690,059 issued to Lemire et al., and entitled HOSPITAL BED; and/or commonly assigned U.S. Pat. publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The mechanical construction of patient support apparatus 10 may also take on still other forms different from what is disclosed in the aforementioned references.

The patient support apparatus 10 may also incorporate a bed exit detection function adapted to issue an alert when a patient exits from patient support apparatus 10. Such an exit detection function may include any of the same features and/or functions as, and/or may be constructed in any of the same manners as, the exit detection systems disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES; U.S. patent application Ser. No. 17/318,476 filed May 12, 2021, by inventors Sujay Sukumaran et al. and entitled PATIENT SUPPORT APPARATUS WITH AUTOMATIC EXIT DETECTION MODES OF OPERATION; and/or the exit detection system disclosed in commonly assigned U.S. Pat. No. 5,276,432 issued to Travis and entitled PATIENT EXIT DETECTION MECHANISM FOR HOSPITAL BED, the complete disclosures of all of which are incorporated herein by reference.

Further details of one type of monitoring system that may be built into the patient support apparatus 10 are disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, as well as commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosures of both of which are incorporated herein by reference. Other types of monitoring systems may be included within patient support apparatus 10 for monitoring parameters of the patient support apparatus 10.

In some aspects, the patient support apparatus 10 may incorporate a scale system that may include any of the same features, components, and/or and functions as the scale systems disclosed in the following commonly assigned patent references: U.S. patent application Ser. No. 62/889,254 filed Aug. 20, 2019, by inventors Sujay Sukumaran et al. and entitled PERSON SUPPORT APPARATUS WITH ADJUSTABLE EXIT DETECTION ZONES; U.S. patent application Ser. No. 63/255,211 filed Oct. 13, 2021, by inventors Sujay Sukumaran et al. and entitled PATIENT SUPPORT APPPARATUS WITH AUTOMATIC SCALE FUNCTIONALITY; U.S. Pat. No. 10,357,185 issued to Marko Kostic et al. on Jul. 23, 2019, and entitled PERSON SUPPORT APPARATUSES WITH MOTION MONITORING; U.S. Pat. No. 11,033,233 issued to Michael Hayes et al. on Jun. 15, 2021, and entitled PATIENT SUPPORT APPARATUS WITH PATIENT INFORMATION SENSORS; U.S. patent application Ser. No. 16/992,515 filed Aug. 13, 2020, by inventors Kurosh Nahavandi et al. and entitled PATIENT SUPPORT APPARATUS WITH EQUIPMENT WEIGHT LOG; and U.S. patent application Ser. No. 63/255,223, filed Oct. 13, 2021, by inventors Sujay Sukumaran et al. and entitled PATIENT SUPPORT APPARATUS WITH PATIENT WEIGHT MONITORING, the complete disclosures of all of which are incorporated herein by reference. The scale system may utilize the same force sensors that are utilized by the exit detection system, in some aspects, or it may utilize one or more different sensors.

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1. A patient support apparatus comprising:
a frame;
a side rail mounted relative to the frame, the side rail being spaced from the frame and movable between raised and lowered positions;
a mattress supported relative to the frame;
a mattress cable assembly for power and/or communications, the mattress cable assembly including a first cable portion connected to the mattress, the mattress cable assembly including a first connector coupled to the first cable portion and connectable to a second connector, the first connector and the second connector forming a connector assembly configured as a breakaway connection, the first connector and the second connector defining a connection axis therebetween along which the first connector and the second connector are configured to be engaged and disengaged; and
a cable support operable to redirect a pulling force applied on the first cable portion to break the first connector away from the second connector without applying force on the first connector that is substantially transverse to the connection axis.

2. The patient support apparatus of claim 1 wherein the first cable portion has a longitudinal axis that extends between the first and second connectors, and wherein the first cable portion is flexible such that the longitudinal axis is capable of being substantially aligned with the connection axis.

3. The patient support apparatus of claim 1 wherein the cable support includes a guide surface that is curved to redirect the pulling force to break the first connector away from the second connector, wherein a curvature of the guide surface is configured to avoid applying force on the first connector that is substantially transverse to the connection axis.

4. The patient support apparatus of claim 3 wherein the curvature of the guide surface includes an apex that is spaced away from the second connector by a distance D.

5. The patient support apparatus of claim 4 wherein the distance D is defined along the connection axis.

6. The patient support apparatus of claim 4 wherein the distance D is sufficiently large so as to enable the first connector to completely disengage from the second connector.

7. The patient support apparatus of claim 4 wherein the curvature of the guide surface has a radius that is greater than or equal to a bend radius of the first cable portion.

8. The patient support apparatus of claim 7 wherein the curvature of the guide surface defines one of a half-circle or a spline curve.

9. The patient support apparatus of claim 1 wherein the second connector is a panel mount connector.

10. The patient support apparatus of claim 1 wherein the cable support includes an opening through which the first connector is capable of passing, the opening including an inner perimeter surface configured to limit transverse movement of the first cable portion relative to the connection axis.

11. A cable support for a patient support apparatus, the patient support apparatus including a frame on which a mattress is supported, the patient support apparatus including a mattress cable assembly with a first connector coupled to a first cable portion connectable to a second connector, the first connector and the second connector forming a connector assembly configured as a breakaway connection, the first connector and the second connector defining a connection axis therebetween along which the first connector and the second connector are configured to be engaged and disengaged, the cable support comprising:
a first guide surface that defines an opening through which the first cable portion and the first connector are capable of passing through, the first guide surface being operable to align a pulling force on the first cable portion in a direction that is substantially transverse to the connection axis; and
a second guide surface that is curved to redirect the pulling force applied on the first cable portion to break the first connector away from the second connector without applying force on the first connector that is substantially transverse to the connection axis.

12. The cable support of claim 11 wherein the first cable portion has a longitudinal axis that extends between the first and second connectors, and wherein the first cable portion is flexible such that the longitudinal axis is capable of being substantially aligned with the connection axis.

13. The cable support of claim 11 wherein a curvature of the second guide surface is configured to avoid applying force on the first connector that is substantially transverse to the connection axis.

14. The cable support of claim 13 wherein the curvature of the guide surface includes an apex that is spaced away from the second connector by a distance D.

15. The cable support of claim 14 wherein the distance D is defined along the connection axis.

16. The cable support of claim 14 wherein the distance D is sufficiently large so as to enable the first connector to completely disengage from the second connector.

17. The cable support of claim 14 wherein the curvature of the guide surface has a radius that is greater than or equal to a bend radius of the first cable portion.

18. The cable support of claim 17 wherein the curvature of the guide surface defines one of a half-circle or a spline curve.

19. The cable support of claim 11 wherein the second connector is a panel mount connector.

20. The cable support of claim 11 wherein the connector assembly is configured as a magnetic breakaway connector assembly.
